(19) United States
(12) Patent Application Publication
(10) Pub. No.: US 2026/0297996 A1
(43) Pub. Date: Oct. 1, 2026

(54) LATCH ASSEMBLIES AND TOOLS USING SUCH LATCH ASSEMBLIES

(71) Applicant: Emerson Professional Tools, LLC, Elyria, OH (US)

(72) Inventors: Jeffrey SZUCS, Ashland, OH (US); Alex Michael COLE, Columbia Station, OH (US); Jon R. DUNKIN, Elyria, OH (US)

(21) Appl. No.: 19/163,315

(22) PCT Filed: Apr. 11, 2024
(86) PCT No.: PCT/US24/23987

§ 371 Date: Sep. 8, 2025

Related U.S. Application Data
(60) Provisional application No. 63/500,686, filed on May 8, 2023.

(30) Foreign Application Priority Data
Apr. 11, 2023 (CN) CN30834972S

(51) Int. Cl. E05C 19/08; B08B 9/04; B25B 15/00; B25H 3/02; B65H 75/36

(52) U.S. Cl. CPC E05C 19/08; B08B 9/04; B65H 75/364; B25B 15/008; B25H 3/02

(57) ABSTRACT

Latch assemblies are described having a positionable handle rotatably secured to a base of a first housing member. The latch assemblies also have a movable latch member configured to contact a catch of a second housing member. The latch assemblies also include a guard that generally surrounds the handle upon positioning the handle to an engaged position. The guard limits access to the handle. In order to move the handle and disengage the latch assembly, a tool is required for insertion into a recess defined by the guard.

### FIELD

The present subject matter relates to latch assemblies and particularly, improved over-center draw latch assemblies, tools and enclosures using such, and related methods.

### BACKGROUND

Over-center draw latches have been used for many decades as a reliable and secure way to latch doors, hatches, and other closures in a wide variety of applications. The basic design of the over-center draw latch has remained relatively unchanged, but there have been some notable developments in its history.

The first over-center draw latches were likely developed in the early 20th century as a simple and effective way to secure doors and hatches on industrial machinery and vehicles.

These early latches consisted of a simple hook or latch mechanism that was drawn over-center to secure the closure. They were often made from metals such as steel and were manually operated.

The design of over-center draw latches was improved with the addition of a spring biased mechanism. This made it easier to operate the latch with one hand and allowed for a more secure closure. This design also allowed for more precise control over the amount of force required to secure the latch, making it possible to adjust the tension to suit different applications.

Subsequently, a new type of over-center draw latch was developed that used a cam mechanism to provide a more secure and reliable closure. This design, known as a cam-over latch, uses a cam mechanism to pull the latch over-center, providing a strong and secure closure that is resistant to vibration and shock. Cam-over latches are now widely used in applications where a secure closure is critical, such as in the aerospace, defense, and transportation industries.

In recent years, the development of new materials and manufacturing techniques has led to the production of over-center draw latches that are lighter, stronger, and more durable than previously known latch assemblies. These new latches are often made from high strength plastics and composites, and they may incorporate features like adjustable tension, tamper-proof locking mechanisms, and corrosion resistant coatings.

A common feature of many over-center draw latches is the mechanism for gripping the handle of the latch. In general, the handle of an over-center draw latch is designed to be easy to grasp and operate, with a shape and texture that provides a secure grip even in wet or slippery conditions.

The handle of an over-center draw latch typically consists of a lever or knob that is attached to the latch mechanism. When the handle is pulled or rotated by a user, the latch mechanism is actuated, drawing the latch over-center and securing the closure.

The design of the handle can vary depending on the specific application and the preferences of the user. Some handles are designed to be operated with one hand, while others require two hands to operate. Some handles may have a locking mechanism to prevent unauthorized access, while others may have an adjustable tension mechanism to allow the user to adjust the amount of force required to secure the latch.

Certain industrial regulations, such as IEC 62841, require the use of tools to open particular types of containers or enclosures, in order to restrict them from being opened by hand.

Other industries may also have regulations or standards that require certain types of containers or enclosures to be secured with a tool or key to prevent unauthorized access. For example, the pharmaceutical industry may require drug storage containers to be secured with a locking mechanism that can only be opened using a special tool or key, to prevent theft or tampering. However, these assemblies are typically complex and costly.

Overall, the use of tools to open containers or enclosures is required in many industries to ensure that equipment is properly secured and only accessible to authorized personnel. Although mandated in certain applications, a need remains for an improved latch assembly and particularly an over-center draw latch assembly that can be readily utilized in a wide array of applications and that requires an ordinary tool to open, yet which is reliable, durable and inexpensive.

### SUMMARY

The difficulties and drawbacks associated with previous approaches are addressed in the present subject matter as follows.

In one aspect, the present subject matter provides a latch assembly for releasably securing a first member to a second member. The latch assembly comprise a handle including a hinge. The handle defines a first lateral side, an oppositely directed second lateral side, an outer face extending between the first and second lateral sides, and a distal end located opposite the hinge. The hinge secures the handle to a base of the first member. The handle is positionable between a first position in which the latch is engaged and the first member is secured to the second member, and a second position in which the latch is disengaged and the first member is unsecured from the second member. The latch assembly also comprises a latch member affixed to the handle and configured to contact a catch of the second member when the handle is positioned to the first position. The latch assembly further comprises a guard extending at least partially around the handle. The guard defines a recess adapted to receive insertion of a tool for contacting and positioning of the handle.

In another aspect, the present subject matter provides a drain cleaner comprising an enclosure having a first member and a second member, and at least one latch assembly including a handle including a hinge. The handle defines a first lateral side, an oppositely directed second lateral side, an outer face extending between the first and second lateral sides, and a distal end located opposite the hinge. The hinge is for securing the handle to a base of the first member. The handle is positionable between a first position in which the latch is engaged and the first member is secured to the second member, and a second position in which the latch is disengaged and the first member is unsecured from the second member. The drain cleaner also comprises a latch member affixed to the handle and configured to contact a catch of the second member when the handle is positioned to the first position. The drain cleaner also comprises a guard extending at least partially around the handle. The guard defines a recess adapted to receive insertion of a tool for contacting and positioning of the handle.

In yet another aspect, the present subject matter provides a latch assembly comprising a handle including a hinge, the handle defining a first lateral side, an oppositely directed second lateral side, an outer face extending between the first and second lateral sides, and a distal end located opposite the hinge. The hinge is for securing the handle to a base of the first member. The handle is positionable between a first position in which the latch is engaged and the first member is secured to the second member, and a second position in which the latch is disengaged and the first member is unsecured from the second member. The latch assembly also comprises a latch member affixed to the handle and configured to contact a catch of the second member when the handle is positioned to the first position. The latch assembly also comprises a guard extending along at least one of (i) the first lateral side of the handle, (ii) the second lateral side of the handle, and (iii) the distal end of the handle. The guard defines a recess adapted to receive a tool for contacting and positioning of the handle. The tool having an actuator end, wherein the actuator end is sized and shaped for insertion into the recess defined by the guard.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1A illustrates an embodiment of a latch assembly in an engaged position in accordance with the present subject matter.

FIG. 1B illustrates the latch assembly of FIG. 1A in a disengaged position.

FIG. 2 illustrates the latch assembly of FIG. 1A in an engaged position and a tool for disengaging the latch assembly.

FIG. 3 is a schematic cross sectional view of the latch assembly depicted in FIGS. 1A and 1B, further illustrating the latch assembly in engaged and disengaged positions.

FIG. 4 is a front view of a drain cleaning tool utilizing a latch assembly to secure housing members together in accordance with the present subject matter.

FIG. 5 is a side view of the drain cleaning tool and latch assembly depicted in FIG. 4.

FIG. 6 is a schematic cross sectional view of the drain cleaning tool shown in FIG. 4.

FIG. 7 is a perspective view of a portion of the drain cleaning tool shown in FIG. 4.

### DETAILED DESCRIPTION OF THE EMBODIMENTS

The present subject matter relates to latch assemblies, tools and enclosures using such, and related methods of using the latch assemblies for example to secure and/or engage tool enclosures together.

### Latch Assemblies

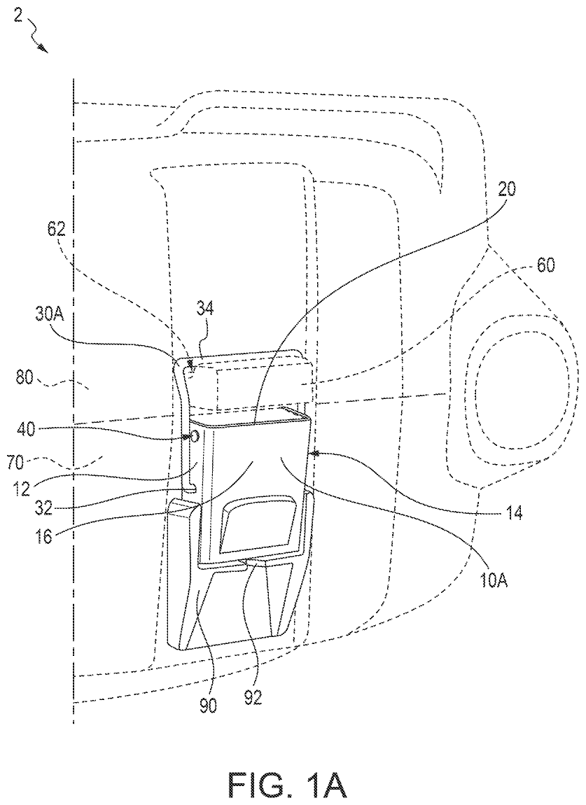

FIGS. 1-3 illustrate an embodiment of a latch assembly 2 in accordance with the present subject matter. The latch assembly 2 is described and illustrated in conjunction with housing or enclosure members such as used in housings or enclosures for tools. The latch assembly 2 selectively affixes housing components together, and upon disengagement, releases the housing components from one another. As described herein, the latch assembly can only be disengaged by use of a particular tool.

The latch assembly 2 comprises a handle 10 defining a first lateral side 12, an oppositely directed second lateral side 14, an outer face 16 extending between the lateral sides 12 and 14, and an inner face 18 generally directed opposite from the outer face 16. The handle 10 also comprises a distal end 20. In the referenced figures, the handle is shown as either 10A or 10B, depending upon its position as described herein.

The latch assembly 2 also comprises a latch member 30. The latch member 30 is movably affixed to the handle 10, typically at a proximal end 32 of the latch member 30. The latch member 30 also defines a distal end 34 generally opposite from the proximal end 32. In the referenced figures, the latch member 30 is shown as either 30A or 30B, as described herein.

The latch assembly 2 also comprises a hinge 40 about which the handle 10 is positionable. The hinge 40 provides for movement and preferably rotatable movement of the handle.

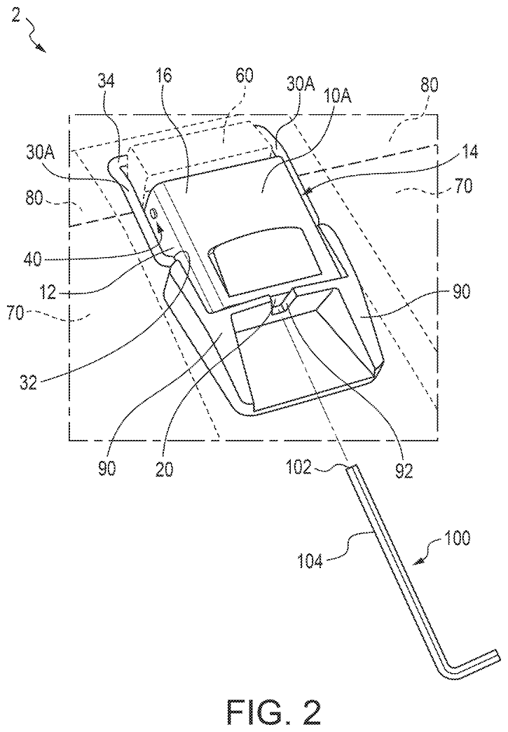

The latch assembly 2 is used in association with a base 50 as shown in FIG. 3 extending from or otherwise associated with a first housing or enclosure member 70. The base 50 can be integrally formed with the first housing member 70, or attached thereto. Non-limiting examples of housing or enclosure members include cases, containers, outer bodies and/or portions thereof such as for tools, machinery or other equipment. The base 50 defines a hinge capture region 52 which cooperates with the hinge 40 to provide for positioning of the handle 10 about the hinge 40.

The latch assembly 2 is also used in association with a catch 60 extending from or otherwise associated with a second housing or enclosure member 80. The catch 60 can be integrally formed with the second housing member 80, or attached thereto. The catch 60 defines a receiving region 62 which contacts the distal end 34 of the latch member 30. The latch member 30 is movably affixed to the handle 10 and configured to contact the catch 60 of the second housing or enclosure member 80 when the handle 10 is positioned to a first engaged position. The receiving region 62 can be configured in a wide array of arrangements and forms. Nonlimiting examples include a recess or groove sized and shaped to fittingly engage the latch member 30. It is also contemplated to utilize prong(s) or outwardly extending member(s) that receive and engage the latch member 30.

The handle 10 is positionable between a plurality of positions. In the accompanying figures, the handle 10 is shown in a first position in which the latch assembly 2 is engaged and the first housing member 70 is secured to the second housing member 80. The figures illustrate the handle 10 and the latch member 30 in an engaged position by a suffix A, i.e., 10A and 30A, respectively. The handle 10 is also shown in a second position in which the latch assembly 2 is disengaged and the first and second housing members 70, 80 are unsecured or movable relative to each other. The figures illustrate the handle 10 and the latch member 30 in a disengaged position by the suffix B, i.e., 10B and 30B, respectively. As previously noted, FIGS. 1A, 2, and 3 depict the latch assembly 2 in an engaged position, and FIGS. 1B and 3 in disengaged positions. It will be understood that the handle 10 and the latch member 30 can be positioned to other positions not depicted in the figures in which the latch assembly 2 is disengaged and the first and second housing members 70, 80 are unsecured or movable relative to each other.

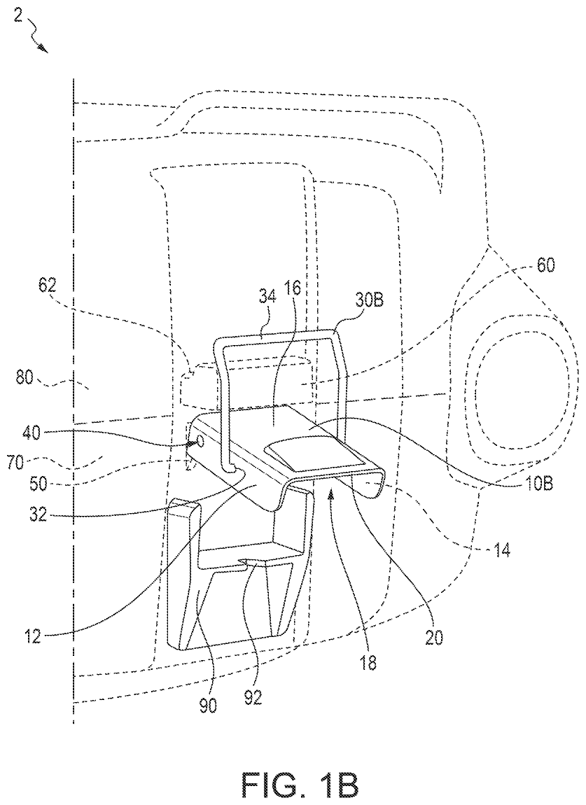

The latch assembly 2 also comprises a guard 90. The guard extends at least partially around the handle 10. The guard defines a recess 92 adapted to receive a tool 100 shown in FIG. 2 for contacting and positioning of the handle 10. In many versions of the latch assembly 2, the guard 90 extends along the first lateral side 12 of the handle 10, the second lateral side 14 of the handle 10, and the distal end 20 of the handle. In particular versions of the latch assembly 2, the guard 90 extends along at least two of the first lateral side 12 of the handle 10, the second lateral side 14 of the handle 10, and the distal end 20 of the handle. In a specific version of the latch assembly 2, the guard 90 extends along the first lateral side 12 of the handle 10, the second lateral side 14 of the handle 10 until it reaches or is adjacent the proximal end 32 of the latch member 30.

Generally, the guard 90 restricts access to the inner face 18 of the handle 10 and to the distal end 20 of the handle 10. Access is restricted but allowed through the recess 92 defined by the guard 90. The lateral sides 12 and 14 are also restricted by the guard 90 to prevent actuation of the handle 10.

Access to the inner face 18 and/or to the distal end 20 of the handle 10, through the recess 92 of the guard 90 can be achieved by inserting the tool 100 in the recess 92 and contacting one or both of the inner face 18 and/or the distal end 20 with the tool 100. Upon contacting the tool 100 with the inner face 18 and/or the distal end 20, the handle 10 can be displaced by appropriate movement of the tool 100. In this manner, the handle 10 and the latch member 30 can be selectively positioned to thereby disengage the latch assembly 2 from a previous engaged state or position. FIG. 2 illustrates the tool 100 having an actuator end 102 and a grip 104. The actuator end 102 is sized and shaped to enable insertion into the recess 92 of the guard 90 and subsequent contact between the actuator end 102 and the handle 10 to position the handle 10 to a disengaged position. It will be understood that the present subject matter includes a wide array of shapes and configurations for the tool 100. In many embodiments, the tool 100 may be an Allen wrench, hex key, or other tool which can fit within the recess to actuate the handle. Moreover, the size, shape, arrangement, location, and/or configuration of the recess 92 defined in the guard 90 can also be varied, in accordance with the present subject matter. That is, the present subject matter is not limited to the particular embodiment illustrated in the referenced figures.

In certain versions of the latch assembly 2, the guard 90 restricts access to the handle 10, yet does not extend over nor preclude viewing of the outer face 16 of the handle 10. In this manner, the guard 90 does not interfere with movement or displacement of the handle 10. Furthermore, enabling viewing of the handle 10, provides visual feedback to a user that the latch assembly 2 is in an engaged state, or not.

### Tools and Enclosures

The present subject matter also provides a wide array of tools and tool enclosures using the noted latch assemblies. Nonlimiting examples of such tools include power tools, compressors, drain cleaning equipment, electrical utility tools, plumbing tools, other construction tools, carrying cases, tool benches and workstations and the like.

A preferred tool having an enclosure with one or more latch assemblies is a drain cleaning tool having a drum housing and components as follows.

The drum housing serves to store and/or retain a drain cleaning cable and may additionally promote dispensing and/or retraction of the cable. The drum housing also includes a drum or cable carrier which is rotatably mounted within the interior of the drum housing. The drain cleaning tools and systems also comprise a transmission assembly for transferring rotary power from a power source to the drain cleaning cable. For example, the drain cleaning tool also comprises a transmission to which a rotary power source such as a drill is engaged. The transmission is capable of effectively transmitting energy such as rotary motion from the power drill or alternative power source directly to an input side of the transmission which may be a flexible shaft or other component of the transmission. The transmission may additionally include provisions for selectively transferring power from the power drill or other power source to the drain cleaning cable. An example of such provisions is a power control switch. Providing a readily accessible power control switch of the system to users, gives the user greater control and more precise control of the cleaning process.

The cable carrier is configured to rotate within the stationary drum housing, in such a way that the cable carrier is not in direct contact with the user. This helps reduce the occurrence of pinch points particularly when the system is used or transported.

The drum housing provides an interior region within which the drain cleaning cable is stored or retained during non-use. The drum housing is typically cylindrically shaped or partially cylindrical in shape. However, the present subject matter is not limited to cylindrical shapes or drum shapes and includes a wide array of other shapes and configurations. In particular versions, the drum housing is configured to typically lay horizontally when in use, and to typically stand vertically when in storage. In this regard, the term “horizontal” refers to the plane of a front face of the drum housing oriented generally horizontal or parallel to a floor or substrate. And the term “vertical” refers to the plane of the front face of the drum housing oriented generally vertical.

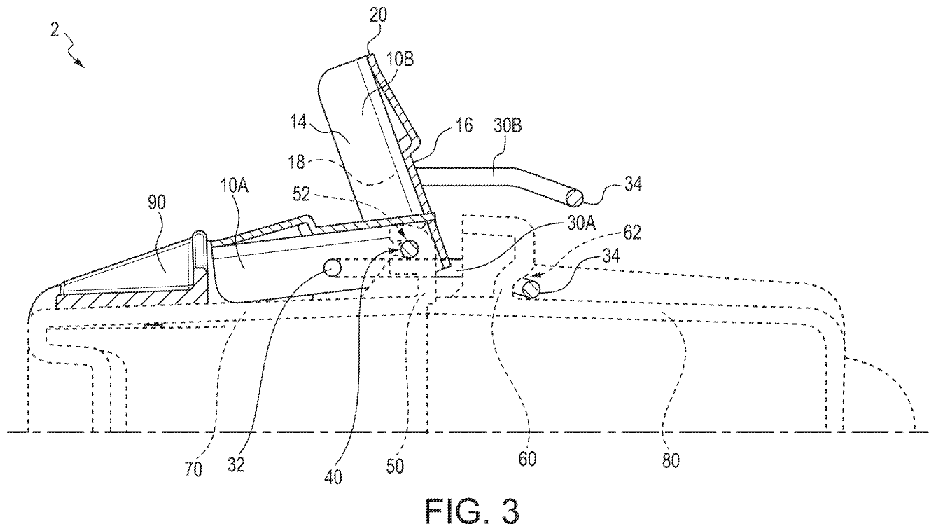

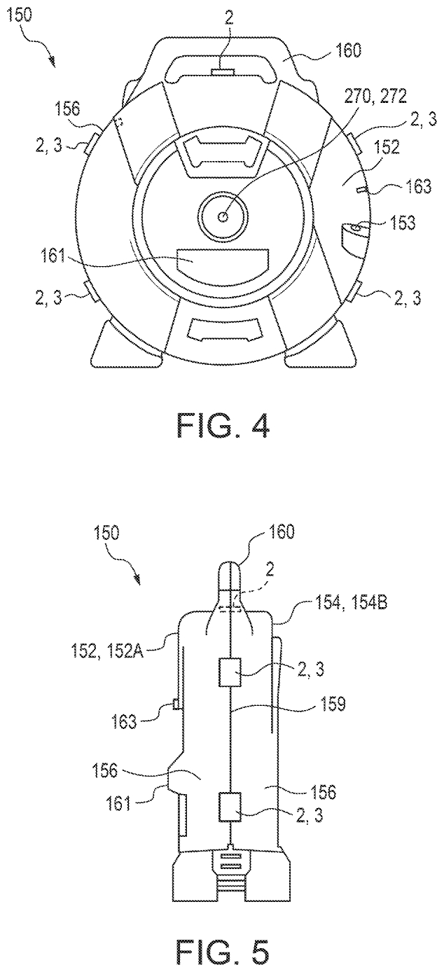

The drum housing can be formed from injection molded polymeric material. The drum housing can be provided in a clamshell configuration. In such versions, the drum housing comprises front and back components, which may or may not be identical. FIGS. 4 and 5 illustrate an embodiment of a drain cleaning tool (herein a “drum housing 150”) in accordance with the present subject matter. The drum housing 150 includes a front wall 152, an oppositely directed rear wall 154, and a generally circumferential side wall 156 extending between the front and rear walls 152, 154. In the particular version shown in the referenced figures, the drum housing is formed from a front component 152A and a rear component 154B which contact and engage each other along an interface 159 that generally bisects the drum housing 150. The drum housing 150 also defines a cable port 153 through which the drain cleaning cable may extend. The cable port 153 provides access into the interior of the drum housing 150. The cable port 153 can include a protective insert which can serve to protect against wear on the drum housing 150 as the cable is advanced or retracted relative to the drum housing 150. The protective insert may be formed from a material exhibiting a relatively low coefficient of friction and in certain versions, such material exhibits a coefficient of friction that is less than the coefficient of friction of the material of the drum housing. In particular versions, the inner span or opening, i.e., inner diameter, of the protective insert is slightly larger than the outer diameter of the cable, thereby resulting in the protective insert also providing a wiping function to rid excess liquid or debris on the outer surface of the cable as the cable is retracted into the drum housing 150. The drum housing 150 optionally includes a transport handle 160 typically extending from the side wall 156. The drum housing 150 may also include a secondary transport handle 161 provided along an outer face such as on the front wall 152. The drum housing 150 may additionally include a cable retention clip 163 typically provided near the cable port 153. The cable retention clip 163 serves to releasably engage a portion such as a distal end or other region of the cable. Retaining or holding the cable along the drum housing 150 promotes ease in transporting and storing the drum housing 150 when containing cable. Otherwise, the interior cable carrier can rotate relative to the drum housing and cable may be inadvertently advanced or fed out from the drum housing.

The housing sections, i.e., front and rear components 152A and 154B, are typically secured together via at least one latch assembly located along the periphery of the drum housing. FIGS. 4 and 5 illustrate a drain cleaning tool utilizing at least one latch assembly 2 in accordance with the present subject matter. The at least one latch assembly 2 serves to secure the front and rear components 152A and 152B together. The front and rear components 152A and 152B can be secured together by use of a single latch assembly 2 or a plurality of latch assemblies 2. It is also contemplated to use one or more latch assemblies 2 in combination with one or more conventional latch assemblies, designated as latch assemblies 3 in the referenced figures. It will be understood that the present subject matter includes nearly any location and/or orientation of one or more latch assemblies 2 on the drum housing 150. That is, the present subject matter is not limited to locating a latch assembly 2 adjacent the handle 160. Nor is the present subject matter limited to the locations for either a latch assembly 2 or a conventional latch assembly 3 as shown in the referenced figures.

The drain cleaning cable used in the tools and systems of the present subject matter typically includes a protective sheath, a rotatable shaft, cable, or component located within the sheath, a driver end coupling which is typically crimped onto the shaft or cable, and one or more collars crimped on the cable on the end opposite of the driver end. Such additional collars may also serve to protect the cable from components such as set-screws, and/or provide precise locations for tool spacing.

The cable transmits torque from the transmission to the distal end of the cable at which is located the cleaning attachment or tool. As will be understood, torque transmission is performed by the inner rotatable shaft. If a cable construction is used instead of a shaft, the inner rotating cable for torque transmission may for example be constructed of high tensile strength wires, for example steel, wrapped around an inner core. The cable includes multiple layers of the same wire without an inner core. Multiple layers of wire typically constitute the desired diameter of cable, which also affects the flexibility of the resulting cable, and therefore, range of pipe sizes the cables are effectively capable of cleaning. Cables or layers thereof, may or may not be wound in opposing directions, which is a method utilized for manufacturing cables capable of withstanding torque in either the clockwise or counter-clockwise direction.

The driver end is the location at which mechanical power is transferred from the transmission. The fitting to which the transmission is coupled is typically mechanically crimped onto the cable, and comprises a bucket end type configuration, with an assembly of a shoulder screw, pin, detent pin, and/or shear pin to function as a coupling pin to connect the transmission to the crimped fitting of the cable.

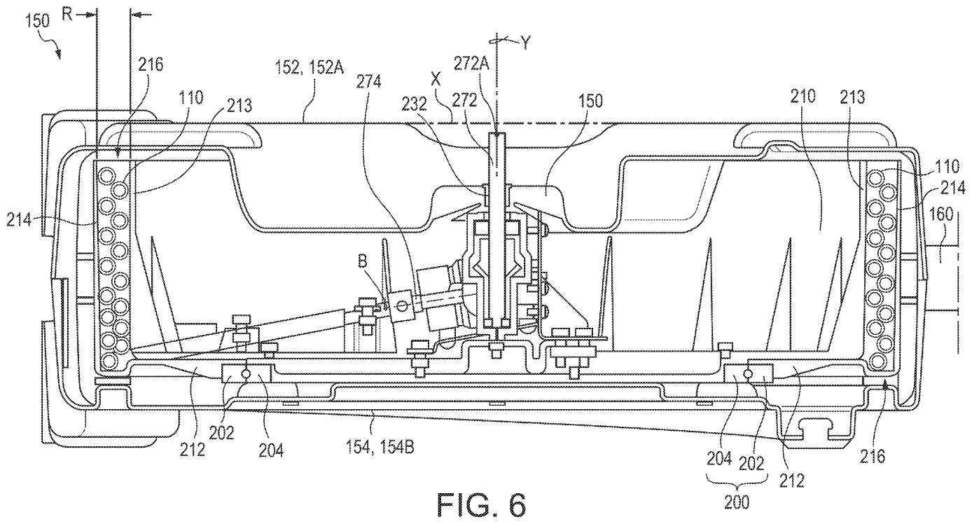

Positioned within the drum housing 150 is the rotatable cable carrier. There are several functions for the internal drum cable carrier. A primary function is to hold the drain cleaner cable when not in use, and to smoothly displace cable when in use. FIG. 6 shows a schematic cross section of the drum housing 150, with a drum or cable carrier 210. The cable carrier 210 is rotatably mounted within the interior of the drum housing 150. The cable carrier 210 is typically circumferentially shaped and includes a rear wall 212 and a circumferential side wall 214. As previously noted, the cable carrier 210 is rotatably supported within the drum housing 150 by a bearing assembly 200. One or more bushings 232 can be utilized to promote rotation of an input shaft 272 relative to the drum housing 150. The bushing(s) 232 may also serve to provide rotational support of the input shaft 272. In particular versions, a distal face 272A of the input shaft 272 is located below the plane X of the front wall 152 as shown in FIG. 6.

The cable carrier 210 can be configured to provide a cable channel 216 in which the drain cleaning cable 110 is stacked or coiled, which is illustrated in FIG. 6. The cable channel 216 is typically located alongside an interior face of the circumferential side wall 214 and in many versions between the circumferential side wall 214 and a secondary internal side wall 213. In these versions, the side walls 214 and 213 extend transversely from the rear wall 212. In certain embodiments, the secondary internal side wall 213 is typically concentrically positioned within the side wall 214 and is spaced therefrom by a radial distance R. Thus, in these versions, R constitutes a width dimension of the cable channel 216. The rear wall 212 can also include a depression or recessed receiving region to facilitate retaining of the drain cleaning cable 110 near the side wall 214. FIG. 6 further illustrates the bearing assembly 200 with races 202, 204 rotatably supporting the cable carrier 210 within the interior of the drum housing 150.

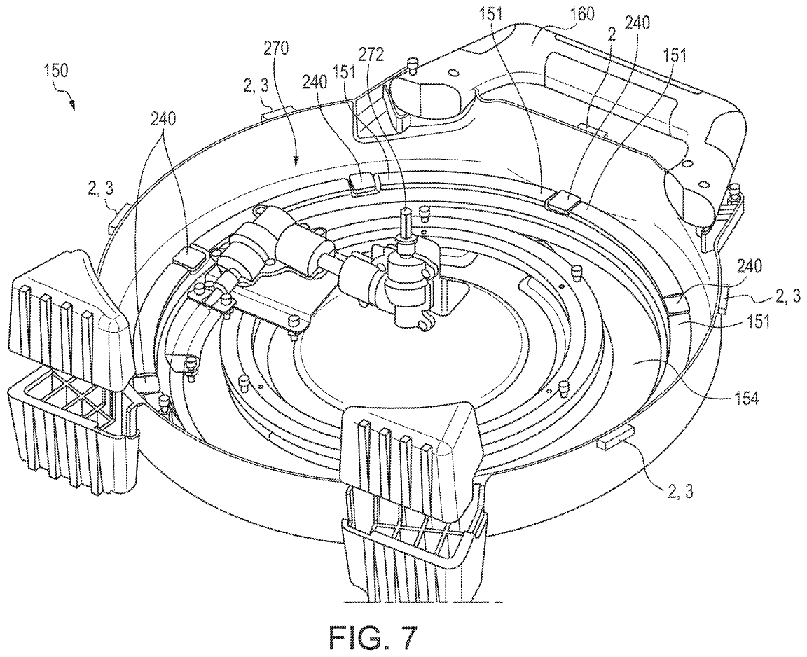

FIG. 7 shows another view of the system with the inner cable carrier removed. Thus, in this figure the transmission assembly 270 and a cable retention platform (described in greater detail herein) are shown “floating.” Underneath the rotatable cable carrier 210 (not shown in FIG. 7), i.e., along the rear wall 154, are a plurality of optional wear pads 240 typically made from polymeric material. Typically, the wear pads are formed from a material exhibiting a relatively low coefficient of friction. Typically, the material of the wear pads exhibits a coefficient of friction that is less than the coefficient of friction of the material of the drum housing. These wear pads 240 are configured to make contact with the rotating cable carrier 210 in the event the carrier 210 is stressed and contacts the interior of the drum housing 150. In many versions, the wear pads 240 are raised and extend above adjacent surface(s) of the drum interior shown in FIG. 7 as surfaces 151. The wear pads 240 also serve a structural function. In the event the machine is dropped or otherwise stressed, the pads 240 make contact with the cable carrier 210 to help safely redirect forces to the drum housing 150. The pads 240 are adhered to the interior of the drum housing 150, but may also be fastened mechanically. However, many embodiments allow the pads 240 to be replaced.

The devices, apparatuses system also comprises an assembly for transferring rotary power from a drill or other power source to the drain cleaning cable. The transmission allows the user to maintain a stationary location at which a power drill or other power source is connected. In many embodiments, the transmission includes an input shaft that will rotate, but not translate with respect to the system during use. The transmission also comprises an output component for delivering rotary power to a cable end within the interior region of the drum housing and more particularly within the cable carrier. The transmission is generally shown as transmission 270 in the referenced figures.

A wide array of rotary power sources can be coupled to the input shaft of the transmission for providing rotary power to the transmission and ultimately to the drain cleaning cable. Power drills can be used. Although battery powered drills are preferred for many applications, corded drills can also be used. It is also contemplated that other portable rotary power sources can be used. In addition, impact power tools could be used to supply rotary power to the transmission.

In many embodiments, the input shaft 272 of the transmission 270 is located and accessible along the front wall 152 of the drum housing 150. And, in particular versions, the input shaft 272 is located at a central location along the front wall 152 of the drum housing 150, such as shown in FIG. 4. Positioning the input shaft 272 at a central location and orienting the shaft 272 to rotate about an axis Y as shown in FIG. 6 that is parallel, coextensive, or coaxial with an axis of rotation of the cable carrier 210, results in improved operational efficiencies and additional benefits.

Referring to FIG. 7, the transmission 270 may comprise one or more gears that redirect power from a rotary power source such as a user supplied device. The transmission 270 may additionally use belt(s). The input shaft 272 may be in the form of a hex shape shaft that accepts a multipoint Jacob's chuck from the user supplied power source. The present subject matter can include other configurations for the input shaft. Non-limiting examples of other configurations for the input shaft 272 include shaft cross sectional shapes that are square, triangular, round, oval, and other shapes. Power is transferred from the input shaft, through a series of gearboxes comprised of miter, bevel, or spiral bevel gears, and redirected to an output 274 and ultimately to the crimped fitting on the drain cleaning cable. The cable can be coupled to one of the shafts on the gearbox with a pin or shoulder screw. In many versions, it may be preferred to couple the cable to one of the shafts on the gearbox with a headed detent pin. The present subject matter includes other engagement or coupling provisions such as shear pin(s) or other pin(s) as known in the art. Additional description and details of drain cleaning tools and related components are provided in U.S. Ser. No. 17/210586 filed Mar. 24, 2021; and U.S. Ser. No. 17/207850 filed Mar. 22, 2021.

Although the one or more latch assemblies 2 are described herein as used with a drain cleaning tool, it will be understood that the latch assemblies can be used with a wide array of other tools and housings or enclosures for such.

### Methods

The present subject matter also provides various methods of securing two or more components together by use of the latch assemblies described herein. As noted, typically the components to be releasably secured together are tool housing members. Referring to FIGS. 1-3, the housing members 70 and 80 are moved into proximity to one another if not already in such a position. The handle 10 is rotated about the hinge 40 toward the catch 60 to thereby enable the latch member 30 to swing over the catch 60. The distal end or region 34 of the latch member 30 is positioned within the receiving region 62. Then, the handle 10 is rotated about the hinge 40 away from the catch 60 and toward the base 40 so that the distal end 34 of the latch member 30 is firmly retained within the receiving region 62. Typically, rotation of the handle 10 about the hinge 40 continues until the handle 10 contacts or is in close proximity to the first housing member 70. The latch assembly 2 is in an engaged state or position.

In this engaged position, the guard 90 extends and/or generally surrounds the handle thus preventing gripping of the handle 10 by a user. In many versions of the latch assembly 10, the guard 90 does not extend over or preclude viewing of the outer face 16 of the handle 10.

In order to disengage the latch assembly 2, a user inserts the tool 100 into the recess 92 defined in the guard 90 and urges the handle 10 toward a disengaged position. Typically, this is performed by contacting the inner face 18 and/or the distal end 20 of the handle 10 with the tool 100, for example the actuator end 102 of the tool 100; and displacing the handle 10 to rotate about the hinge 40 toward the catch 60 and the second housing component 80. The handle 10 is further positioned to release the latch member 30 from the catch 60 to thereby allow the second housing component 80 to be moved or positioned independently from the first housing component 70.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

1. A latch assembly for releasably securing a first member to a second member, the latch assembly comprising:
a handle including a hinge, the handle defining a first lateral side, an oppositely directed second lateral side, an outer face extending between the first and second lateral sides, and a distal end located opposite the hinge, the hinge for securing the handle to a base of the first member, the handle positionable between a first position in which the latch assembly is engaged and the first member is secured to the second member, and a second position in which the latch assembly is disengaged and the first member is unsecured from the second member;
a latch member affixed to the handle and configured to contact a catch of the second member when the handle is positioned to the first position;
a guard extending at least partially around the handle, wherein the guard defines a recess adapted to receive a tool for actuating the handle wherein the guard comprises first and second sidewalls extending along the respective first and second lateral sides of the handle and a connecting wall including the recess and extending between the first and second sidewalls adjacent the distal end of the handle, wherein the guard has an open end opposite the connecting wall.

2. The latch assembly of claim 1 wherein the guard is configured to prevent manual actuation of the handle while allowing tool based actuation through the open end of the recess.

3. The latch assembly of claim 1 wherein the handle further defines an inner face oppositely directed from the outer face, the guard restricting access to the inner face of the handle and the distal end of the handle via the recess defined by the guard.

4. The latch assembly of claim 1 wherein the handle is displaced from the first position to the second position by inserting the tool in the recess and contacting the handle with the tool.

5. The latch assembly of claim 1 wherein the outer face of the handle is exposed and free from coverage by the guard.

6. The latch assembly of claim 1 wherein the tool has an actuator end, wherein the actuator end is sized and shaped for insertion into the recess defined by the guard.

7. The latch assembly of claim 6 wherein upon insertion of the actuator end of the tool into the recess defined by the guard, the actuator end contacts the handle.

8. A drain cleaner comprising:
an enclosure having a first member and a second member;
at least one latch assembly including a handle including a hinge, the handle defining a first lateral side, an oppositely directed second lateral side, an outer face extending between the first and second lateral sides, and a distal end located opposite the hinge, the hinge for securing the handle to a base of the first member, the handle positionable between a first position in which the latch assembly is engaged and the first member is secured to the second member, and a second position in which the latch assembly is disengaged and the first member is unsecured from the second member;
a latch member affixed to the handle and configured to contact a catch of the second member when the handle is positioned to the first position;
a guard extending at least partially around the handle, wherein the guard defines a recess adapted to receive a tool for actuating the handle wherein the guard comprises first and second sidewalls extending along the respective first and second lateral sides of the handle and a connecting wall including the recess and extending between the first and second sidewalls adjacent the distal end of the handle, wherein the guard has an open end opposite the connecting wall.

9. The drain cleaner of claim 8 wherein the guard is configured to prevent manual actuation of the handle while allowing tool based actuation through the open end of the recess.

10. The drain cleaner of claim 8 wherein the handle further defines an inner face oppositely directed from the outer face, the guard restricting access to the inner face of the handle and the distal end of the handle via the recess defined by the guard.

11. The drain cleaner of claim 8 wherein the handle is displaced from the first position to the second position to the latch disengaged position by inserting the tool in the recess and contacting the handle with the tool.

12. The drain cleaner of claim 8 wherein the outer face of the handle is exposed and free from coverage by the guard.

13. The drain cleaner of claim 8 wherein the at least one latch assembly includes a plurality of latch assemblies arranged and located along an outer periphery of the enclosure.

14. The drain cleaner of claim 8 wherein the tool includes an actuator end and a grip, the actuator end sized and shaped to enable insertion of the actuator end of the tool into the recess defined in the guard.

15. A latch assembly comprising:
A handle including a hinge, the handle defining a first lateral side, an oppositely directed second lateral side, an outer face extending between the first and second lateral sides, and a distal end located opposite the hinge, the hinge for securing the handle to a base of a first member, the handle positionable between a first position in which the latch assembly is engaged and the first member is secured to a second member, and a second position in which the latch assembly is disengaged and the first member is unsecured from the second member;
a latch member affixed to the handle and configured to contact a catch of the second member when the handle is positioned to the first position;
a guard extending along (i) the first lateral side of the handle, (ii) the second lateral side of the handle, and (iii) the distal end of the handle, wherein the guard defines a recess adapted to receive a tool for actuating the handle;
wherein the tool includes an actuator end, wherein the actuator end is sized and shaped for insertion into the recess defined by the guard.

16. The latch assembly of claim 15 wherein the outer face of the handle is exposed and free from coverage by the guard.
